(19) United States
(12) Patent Application Publication
(10) Pub. No.: US 2017/0276564 A1
(43) Pub. Date: Sep. 28, 2017

(54) PRESSURE SENSOR-PROVIDED DEVICE

(71) Applicant: SEIKO EPSON CORPORATION, Tokyo (JP)

(72) Inventors: Junichi TAKEUCHI, Chino-shi (JP); Michiko KAWAJI, Kai-shi (JP)

(73) Assignee: SEIKO EPSON CORPORATION, Tokyo (JP)

(21) Appl. No.: 15/448,953

(22) Filed: Mar. 3, 2017

(30) Foreign Application Priority Data
Mar. 22, 2016 (JP) 2016-056601

(51) Int. Cl. G01L 19/14; G04B 47/06; G01C 5/06

(52) U.S. Cl. CPC G01L 19/14; G01C 5/06; G04B 47/066

(57) ABSTRACT

A pressure sensor-provided device includes a pressure sensor, a housing that has an accommodation space which accommodates the pressure sensor, a first channel that has a first opening disposed on an outer surface of the housing, and that connects an outside of the housing and the accommodation space to each other, and a second channel that has a second opening disposed on the outer surface of the housing, and that connects the outside of the housing and the accommodation space to each other. The first opening and the second opening are respectively disposed on sides opposite to each other via a center of the housing.

### BACKGROUND

1. Technical Field

The present invention relates to a pressure sensor-provided device.

2. Related Art

In the related art, a sensor-provided wristwatch including a pressure sensor is known. For example, this sensor-provided wristwatch causes the pressure sensor to measure atmospheric pressure, and has a function to obtain an altitude, based on the measured atmospheric pressure. The sensor-provided wristwatch can know the altitude together with time. Therefore, for example, a pressure sensor-provided wristwatch is used for mountain climbing or trail running. For example, the sensor-provided wristwatch is configured so that the pressure sensor measures water pressure and a water depth value is obtained based on the water pressure. Accordingly, the sensor-provided wristwatch is also used for diving, for example.

As an example of this sensor-provided wristwatch, for example, JP-A-2011-191213 discloses a sensor-provided electronic device that has an exterior case, a sensor unit disposed inside the exterior case so as to detect pressure, and a pressure introduction path introducing outside air to the sensor unit. According to the sensor-provided electronic device disclosed in JP-A-2011-191213, the pressure introduction path introduces the outside air to the sensor unit, and the sensor unit measures atmospheric pressure.

However, according to the sensor-provided electronic device having a configuration disclosed in JP-A-2011-191213, the pressure introduction path introducing the outside air to the sensor unit is disposed at one location. Thus, if wind enters the pressure introduction path, there is no escape route for air inside the sensor unit. Accordingly, internal pressure of the sensor unit is increased due to a wind effect. As a result, the sensor-provided electronic device in the related art has a problem in that detected pressure disadvantageously varies due to the wind effect.

### SUMMARY

An advantage of some aspects of the invention is to provide a pressure sensor-provided device which can reduce pressure variations caused by a wind effect, for example.

The advantage can be achieved by the following configurations.

A pressure sensor-provided device according to an aspect of the invention includes a pressure sensor, a housing that has an accommodation space which accommodates the pressure sensor, a first channel that has a first opening disposed on an outer surface of the housing, and that connects an outside of the housing and the accommodation space to each other, and a second channel that has a second opening disposed on the outer surface of the housing, and that connects the outside of the housing and the accommodation space to each other. The first opening and the second opening are respectively disposed on sides opposite to each other via a center of the housing.

According to the pressure sensor-provided device (hereinafter, simply referred to as a “device”) of the aspect of the invention, for example, when wind blowing to the vicinity of the first opening increases pressure in the vicinity of the first opening and pressure in the vicinity of the second opening becomes lower than the pressure in the vicinity of the first opening, the wind can flow to the second opening after flowing through the first channel and the second channel from the first opening. In this way, the wind entering the inside of the housing can flow outward from the housing. Since air stagnation can be reduced, pressure variations caused by a wind effect can be reduced. Even in a case where the wind blows to the vicinity of the second opening, the wind can flow to the first opening after flowing through the second channel and the first channel from the second opening. Accordingly, The same advantageous effect described above can be achieved.

In the pressure sensor-provided device according to the aspect of the invention, it is preferable that pressure loss of a fluid in the first channel is equal to pressure loss of the fluid in the second channel.

With this configuration, the accommodation space can be a region which is particularly less likely to receive the wind effect. Accordingly, it is possible to effectively reduce pressure variations caused by the wind effect.

In the pressure sensor-provided device according to the aspect of the invention, it is preferable that the accommodation space is disposed at a position shifted from the center of the housing.

With this configuration, for example, in a case where the device has various components, the components can be more freely arranged in the device.

In the pressure sensor-provided device according to the aspect of the invention, it is preferable that at least one of the first channel and the second channel has a portion extending along the outer surface of the housing.

With this configuration, for example, in a case where the device has various components, the components can be more freely arranged in the device.

In the pressure sensor-provided device according to the aspect of the invention, it is preferable that a length of the first channel is longer than a length of the second channel, and that a width of the first channel is wider than a width of the second channel.

With this configuration, it is possible to reduce a difference between the pressure loss in the first channel and the pressure loss in the second channel. It is possible to reduce pressure variations caused by the wind effect. The first channel, the second channel, and the accommodation space can be more freely arranged in the device.

In the pressure sensor-provided device according to the aspect of the invention, it is preferable that the housing has a symmetric plane, and is configured to have a symmetric shape, and that the first opening and the second opening are respectively disposed at positions shifted from the symmetric plane.

With this configuration, it is possible to improve an operation in allowing the wind to flow from the first opening to the second opening. It is possible to effectively reduce pressure variations caused by the wind effect.

It is preferable that the pressure sensor-provided device according to the aspect of the invention further includes a third channel that has a third opening disposed on the outer surface of the housing, and that connects the outside of the housing and the accommodation space to each other, and a fourth channel that has a fourth opening disposed on the outer surface of the housing, and that connects the outside of the housing and the accommodation space to each other.

with this configuration, the wind can flow between the first opening and the second opening. In addition, the wind can flow between the third opening and the fourth opening. For example, the wind entering from the first opening can flow to the second opening, the third opening, and the fourth opening. Therefore, even if the wind blows to the device, the wind entering the inside of the housing from any one opening can flow outward from the housing through any other opening. Accordingly, compared to a configuration having two channels of the first channel and the second channel, it is possible to effectively reduce pressure variations caused by the wind effect.

In the pressure sensor-provided device according to the aspect of the invention, it is preferable that when four regions are defined which are divided by a first plane passing through the center of the housing and a second plane passing through the center of the housing and intersecting the first plane, the first opening, the second opening, the third opening and the fourth opening are respectively disposed inside the different regions.

With this configuration, even if the wind blows to the device in various directions, the wind entering the inside of the housing from any one opening can flow outward from the housing through any other opening. Therefore, regardless of a wind blowing direction, it is possible to effectively reduce pressure variations caused by the wind effect.

It is preferable that the pressure sensor-provided device according to the aspect of the invention further includes a display unit that is disposed in the housing, and that displays time information.

With this configuration, the device according to the aspect of the invention can be used as a pressure sensor-provided timepiece which can obtain time and information relating to pressure. For example, a user uses the timepiece by wearing the timepiece on his or her arm. If the user shakes his or her arm, the timepiece is likely to receive the wind effect. Therefore, the pressure sensor-provided device according to the aspect of the invention is effectively used as the pressure sensor-provided timepiece which is particularly likely to receive the wind effect, since pressure can be more accurately measured.

### BRIEF DESCRIPTION OF THE DRAWINGS

The invention will be described with reference to the accompanying drawings, wherein like numbers reference like elements.

FIG. 1 is a perspective view when a wristwatch serving as an example of a pressure sensor-provided device according to a first embodiment of the invention is viewed from a front surface side.

FIG. 2 is a perspective view when the wristwatch illustrated in FIG. 1 is viewed from a rear surface side.

FIG. 3 is a schematic sectional view of the wristwatch illustrated in FIG. 1.

FIG. 4 is a schematic plan view illustrating an inner space belonging to the wristwatch illustrated in FIG. 1.

FIG. 5 is a schematic sectional view illustrating an accommodation space and a sensor unit, both of which belong to the wristwatch illustrated in FIG. 1.

FIG. 6 is a view illustrating pressure distribution when the wristwatch illustrated in FIG. 1 receives wind.

FIG. 7 is a view illustrating pressure distribution when the wristwatch illustrated in FIG. 1 receives wind.

FIG. 8 is a view illustrating pressure in a cover member and the sensor unit, both of which belong to the wristwatch illustrated in FIG. 1.

FIG. 9 is a schematic side view illustrating the wristwatch illustrated in FIG. 1.

FIG. 10 is a schematic side view illustrating the wristwatch illustrated in FIG. 1.

FIG. 11 is a schematic top view illustrating the wristwatch illustrated in FIG. 1.

FIG. 12 is a schematic plan view of a wristwatch serving as an example of a pressure sensor-provided device according to a second embodiment of the invention.

FIG. 13 is a view illustrating pressure in a sensor unit when the wristwatch illustrated in FIG. 12 receives wind.

FIG. 14 is a schematic plan view of a wristwatch serving as an example of a pressure sensor-provided device according to a third embodiment of the invention.

FIG. 15 is a view illustrating pressure in a sensor unit when the wristwatch illustrated in FIG. 14 receives wind.

FIG. 16 is a schematic plan view of a wristwatch serving as an example of a pressure sensor-provided device according to a fourth embodiment of the invention.

FIG. 17 is a view illustrating pressure in a sensor unit when the wristwatch illustrated in FIG. 16 receives wind.

FIG. 18 is a schematic plan view of a wristwatch serving as an example of a pressure sensor-provided device according to a fifth embodiment of the invention.

FIG. 19 is a view illustrating pressure in a sensor unit when the wristwatch illustrated in FIG. 18 receives wind.

### DESCRIPTION OF EXEMPLARY EMBODIMENTS

Hereinafter, a pressure sensor-provided device according to embodiments of the invention will be described in detail with reference to preferred embodiments illustrated in the accompanying drawings.

### Pressure Sensor-Provided Device

### First Embodiment

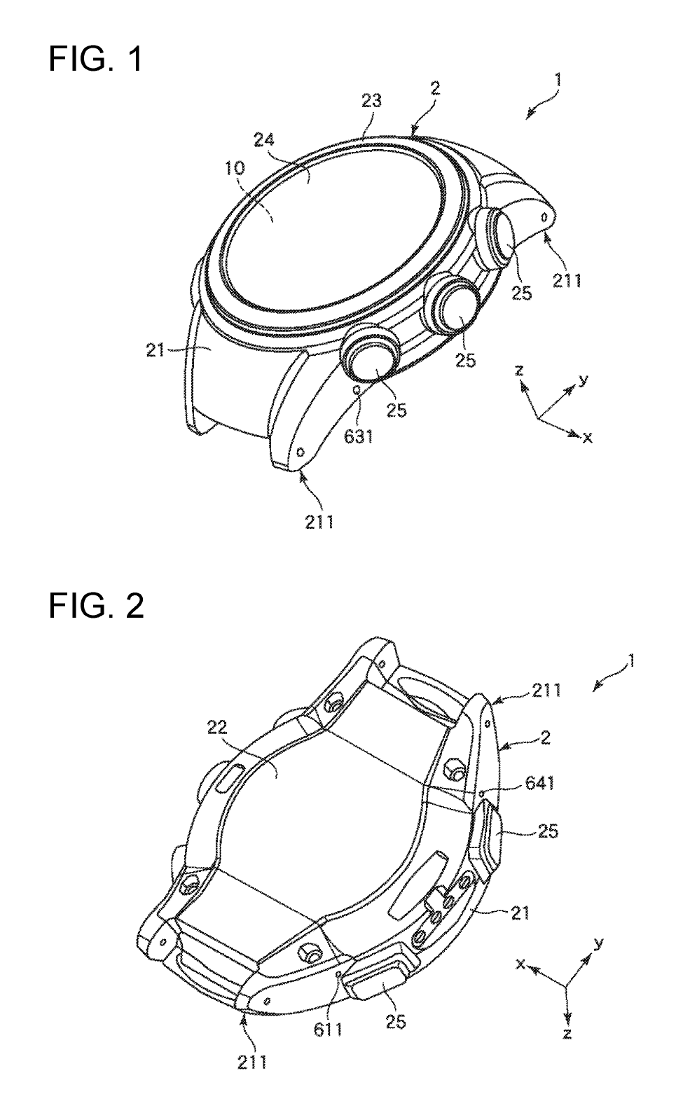

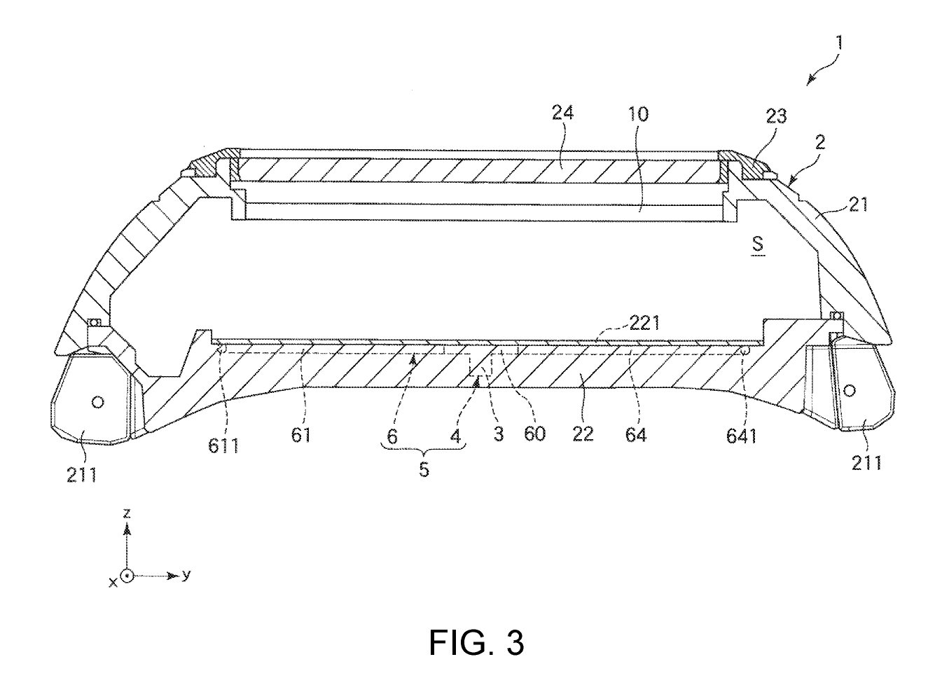

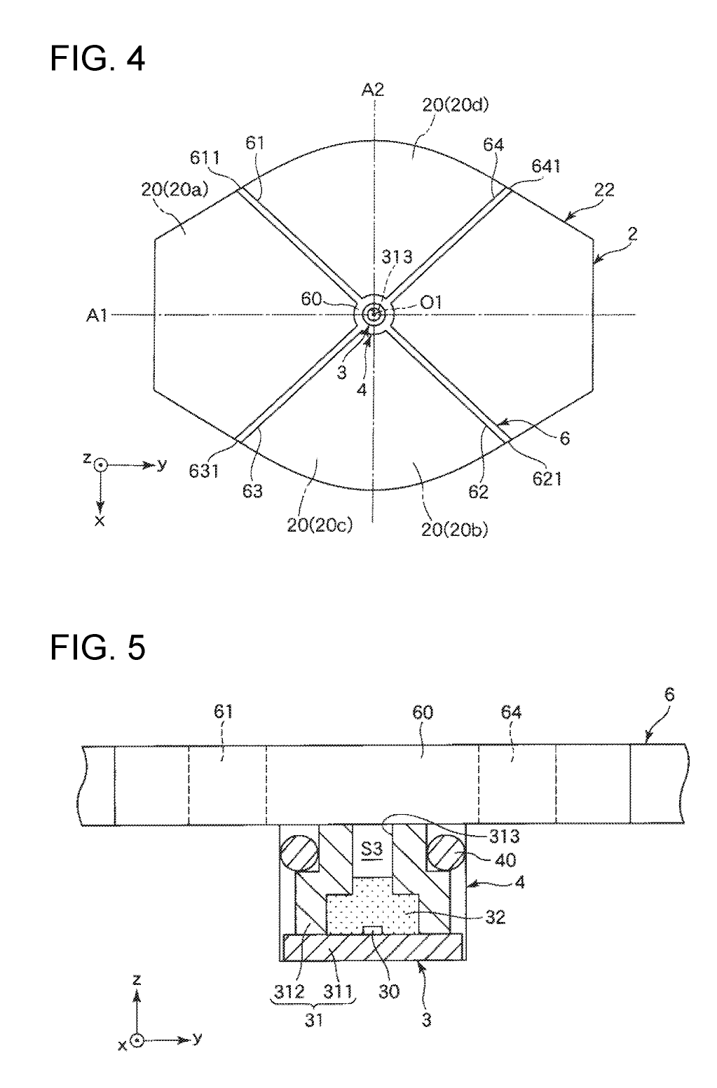

FIG. 1 is a perspective view when a wristwatch serving as an example of a pressure sensor-provided device according to a first embodiment of the invention is viewed from a front surface side. FIG. 2 is a perspective view when the wristwatch illustrated in FIG. 1 is viewed from a rear surface side. FIG. 3 is a schematic sectional view of the wristwatch illustrated in FIG. 1. FIG. 4 is a schematic plan view illustrating an inner space belonging to the wristwatch illustrated in FIG. 1. FIG. 5 is a schematic sectional view illustrating an accommodation space and a sensor unit, both of which belong to the wristwatch illustrated in FIG. 1.

Hereinafter, in order to facilitate description, an upper side in FIGS. 3 and 5 is referred to as “up”, “upward”, or a “front side”. A lower side in FIGS. 3 and 5 is referred to as “down”, “downward”, or a “rear side”.

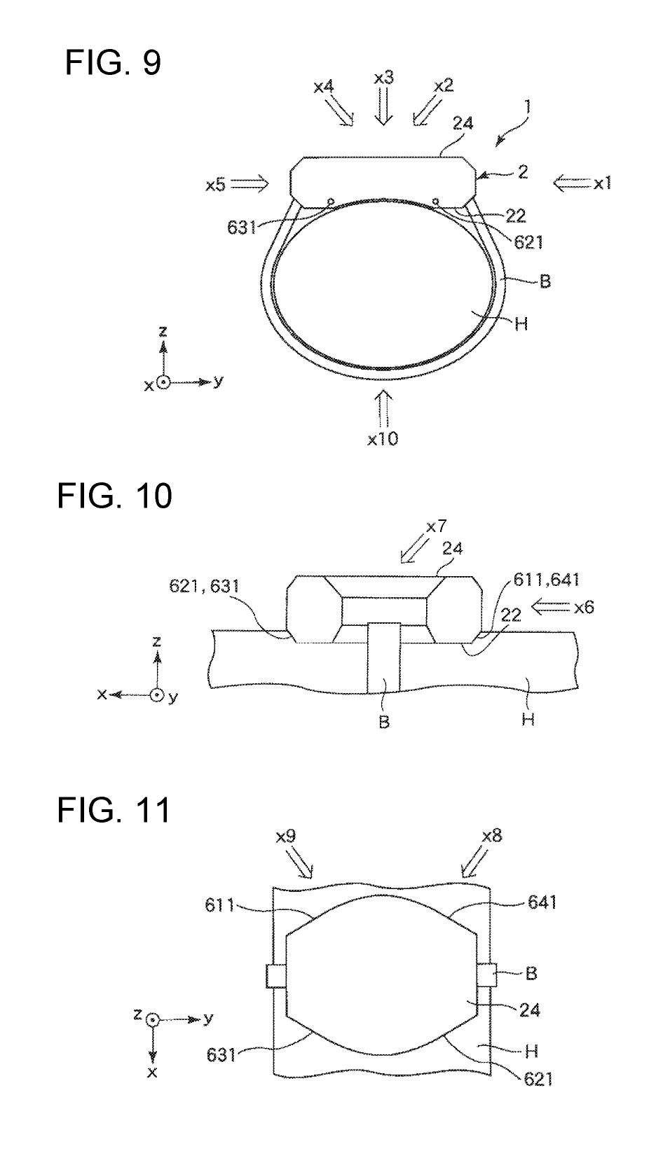

In FIGS. 1 to 5, in order to facilitate description, an x-axis, a y-axis, and a z-axis which are three axes orthogonal to each other are illustrated by each arrow. A distal end side of the arrow is set to “+ (plus)”, and a proximal end side is set to “− (minus)”. Hereinafter, a direction parallel to the x-axis is referred to as an “x-axis direction”, a direction parallel to the y-axis is referred to as a “y-axis direction”, and a direction parallel to the z-axis is referred to as a “z-axis direction”. A plane defined by the x-axis and the y-axis is referred to as an “xy plane”, a plane defined by the y-axis and the z-axis is referred to as a “yz plane”, and a plane defined by the z-axis and the x-axis is referred to as a “zx plane”. These references are similarly applied to FIGS. 9 to 12, 14, 16, and 18 to be described below.

A wristwatch 1 illustrated in FIGS. 1, 2, and 3 is an example of the pressure sensor-provided device according to the invention. For example, the wristwatch 1 is a portable information terminal which can obtain altitude information together with time information.

The wristwatch 1 has a housing 2, an internal space 5 that is disposed inside the housing 2 and which a fluid, for example, such as air enters from the outside of the housing 2, and a sensor unit 3 that detects pressure of the air entering the inside the internal space 5. The internal space 5 has a channel unit 6 through which the air flows, and an accommodation space 4 that communicates with the channel unit 6, and that accommodates the sensor unit 3.

The wristwatch 1 has a control unit (not illustrated) inside the housing 2, and is configured so that the control unit can obtain an altitude, based on the pressure detected by the sensor unit 3.

Hereinafter, respective units configuring the wristwatch 1 will be sequentially described.

### Housing 2

The housing 2 has an annular body 21, a plate-shaped rear cover 22 that is attached to the body 21 so as to close an opening on a rear side of the body 21, an annular bezel 23 that is attached to an inner edge portion on a front side of the body 21, a cover member 24 that is held by the bezel 23 so as to close an opening on the front side of the body 21, and that is configured to include a disc-shaped member, and multiple buttons 25 that are disposed on a side surface of the body 21. Lugs 211 serving as a connection portion for detachably connecting a band (not illustrated) used when being worn on a user's arm are respectively disposed on the +y-axis side and the −y-axis side of the body 21.

As illustrated in FIG. 4, the housing 2 is configured to have a substantially symmetric shape in which a first plane A1 serving as a virtual plane parallel to the yz plane is a symmetric plane. The housing 2 is configured to have a substantially symmetric shape in which a second plane A2 serving as a virtual plane parallel to the zx plane is a symmetric plane. The first plane A1 and the second plane A2 intersect each other after respectively passing through a center O1. In particular, according to the present embodiment, both of these are orthogonal to each other. The first plane A1 is located on a line segment connecting a pair of the lugs 211 after passing through the center O1. Here, the “center O1” means a geometric center of the housing 2, and represents a center in a shape of the housing 2, which does not consider a weight of the housing 2.

As illustrated in FIG. 3, the housing 2 is formed so that the body 21, the rear cover 22, the bezel 23, and the cover member 24 are assembled to each other, and has a component accommodation space S which accommodates various components.

A display unit 10 which can display various information items, for example, such as time information, altitude information, atmospheric pressure information, outside air temperature information, orientation information, position information, and inclination information when necessary is disposed in the component accommodation space S. The display unit 10 is disposed on a rear side of the cover member 24. Here, for example, the cover member 24 is configured to include a permeable member containing glass or a resin. Therefore, a user of the wristwatch 1 can view information displayed on the display unit 10 via the cover member 24. For example, the display unit 10 is configured to include a display panel such as a liquid crystal panel or an organic electroluminescence panel, and a drive circuit for driving the display panel. The user can change information displayed on the display unit 10 by operating the multiple buttons 25.

Although not illustrated, in addition to the display unit 10, various components, for example, such as a battery, a circuit board, an antenna, a temperature sensor, an acceleration sensor, a gyro sensor, and a magnetic sensor are disposed inside the component accommodation space S. For example, the circuit board includes a control unit, a storage unit, a communication unit, a GPS receiver, and a sound output unit. For example, the control unit is configured to include a central processing unit (CPU), and obtains information such as altitude, based on pressure detected by the sensor unit 3. The control unit has a function to control the various components, to generate various information items based on a signal transmitted from the various components, and to display the various information items on the display unit 10. The storage unit is configured to include a recording medium such as a read only memory (ROM) and a random access memory (RAM). For example, the communication unit communicates with an external device such as a smartphone and a personal computer, and transmits the various information items generated by the control unit to the external device. The GPS receiver receives a satellite signal transmitted from a GPS satellite, and calculates a current position or time information of the wristwatch 1, based on orbit information or time information superimposed on the satellite signal. The sound output unit outputs a voice which can be heard outside the housing 2, based on sound information transmitted from the control unit.

Configuration materials of the body 21, the rear cover 22, and the bezel 23 are not particularly limited. For example, it is possible to use a metal material such as stainless steel, a titanium-based alloy, and a gold alloy, or a plastic such as polycarbonate and ABS. The configuration materials of the body 21, the rear cover 22, and the bezel 23 may be the same as each other, or may be different from each other.

The rear cover 22 belonging to the housing 2 has the internal space 5 formed therein.

Hereinafter, the internal space 5 will be described.

### Internal Space 5

As described above, the internal space 5 is a space to which air is introduced from the outside of the housing 2. According to the embodiment, as illustrated in FIG. 3, the internal space 5 is formed in the rear cover 22.

As illustrated in FIGS. 3 and 4, the internal space 5 has the accommodation space 4 which is a recess formed in a central portion of the rear cover 22 in a plane view, and the tubular channel unit 6 which communicates with the accommodation space 4 and which is formed in a cross shape whose center is the accommodation space 4 in a plan view. As illustrated in FIG. 3, the channel unit 6 is formed along a plate surface of the rear cover 22.

The internal space 5 can be formed in such a way that a recess which is open to the front side and which has a planar shape corresponding to the accommodation space 4 and the channel unit 6 is formed in the rear cover 22, and that a plate-shaped member 221 is joined to the rear cover 22 so as to close the opening of the recess.

### Channel Unit 6

As illustrated in FIG. 4, the channel unit 6 has a channel 61 (first channel), a channel 62 (second channel), a channel 63 (third channel), and a channel 64 (fourth channel) which have a tubular shape formed in a straight line shape in a plan view, and a connection portion 60 which connects the channels 61, 62, 63, and 64.

The connection portion 60 is located in a central portion of the rear cover 22 in a plan view, and a planar shape thereof is circular.

The channels 61, 62, 63, and 64 respectively extend from the connection portion 60 toward an outer peripheral surface of the rear cover 22. An end thereof is open to the connection portion 60, and the other end thereof is open to the outer peripheral surface of the rear cover 22. The channel 61 has an opening 611 (first opening) which is open to the outer peripheral surface of the rear cover 22. The channel 62 has an opening 621 (second opening) which is open to the outer peripheral surface of the rear cover 22. The channel 63 has an opening 631 (third opening) which is open to the outer peripheral surface of the rear cover 22. The channel 64 has an opening 641 (fourth opening) which is open to the outer peripheral surface of the rear cover 22.

The channels 61 and 62 are located at the same straight line in a plane view. The channels 63 and 64 are located at the same straight line in a plane view. Therefore, in the channel unit 6, one channel configured to include the channels 61 and 62 and one channel configured to include the channels 63 and 64 intersect so as to be orthogonal to each other. In other words, a configuration is adopted in which the connection portion 60 is present at the intersecting point.

Respective lengths of the channels 61, 62, 63, and 64 are the same as each other. The length represents a distance from the corresponding openings 611, 621, 631, and 641 to the connection portion 60. The channels 61, 62, 63, and 64 respectively have square shapes whose cross-sectional shapes are the same as each other. The channels 61, 62, 63, and 64 are respectively configured to have a constant width and an equivalent diameter. The widths and the equivalent diameters within (inside) the tubes are the same as each other. The channels 61, 62, 63, and 64 have the same pressure loss in the same fluid (for example, air). In other words, according to the embodiment, the channels 61, 62, 63, 64 are respectively caused to have the same cross-sectional shape, the same length, the same width, and the same equivalent diameter, thereby adopting a configuration in which all of these mutually have the same pressure loss in the same fluid. The description of “the same pressure loss” indicates that pressure losses in the same fluid are substantially the same as each other, and means that a slight difference between the pressure losses is allowed. Specifically, the description of “the same pressure loss” means that the difference between both of these is approximately ±10%.

These channels 61, 62, 63, and 64 are not disposed on the first plane A1 and the second plane A2, and are respectively disposed at positions shifted from the first plane A1 and the second plane A2.

When the housing 2 is divided by the first plane A1 and the second plane A2, the channels 61, 62, 63, and 64 are respectively disposed so as to correspond to each divided region 20. The openings 611, 621, 631, and 641 are respectively disposed in the same manner as described above. Hereinafter, the region 20 which is located on the left upper side in FIG. 4 and which has the channel 61 and the opening 611 is referred to as a “first region 20a”. The region 20 which faces the first region 20a with respect to the center O1 and which has the channel 62 and the opening 621 is referred to as a “second region 20b”. The region 20 which is located on the left lower side in FIG. 4 and which has the channel 63 and the opening 631 is referred to as a “third region 20c”. The region 20 which faces the third region 20c with respect to the center O1 and which has the channel 64 and the opening 641 is referred to as a “fourth region 20d”.

The opening 611 and the opening 621 are located on sides opposite to each other via the center O1. The opening 631 and the opening 641 are located on sides opposite to each other via the center O1. In particular, according to the embodiment, the opening 611 and the opening 621 face each other with respect to the center O1. The opening 631 and the opening 641 face each other with respect to the center O1.

The channel unit 6 having this configuration has a symmetric shape in which the first plane A1 serves as a symmetric plane, and has a symmetric shape in which the second plane A2 serves as a symmetric plane.

### Accommodation Space 4

As illustrated in FIGS. 3 and 4, the accommodation space 4 is a recess disposed below (rear side) the connection portion 60, and communicates with the connection portion 60. The opening of the recess has a planar shape which is smaller than a planar shape of the connection portion 60, and is located in a central portion of the connection portion 60 in a plane view. According to the embodiment, the accommodation space 4 has a bottomed cylindrical shape. However, without being limited thereto, a shape of the accommodation space 4 may be a horn shape, for example.

According to the internal space 5 configured as described above, wind entering the internal space 5 from any one opening of the openings 611, 621, 631, 641 can flow outward from the housing 2 through an opening different from the opening which the wind enters before.

### Sensor Unit 3

As illustrated in FIG. 5, the sensor unit 3 is disposed in the accommodation space 4, and has a package 31, a pressure sensor 30 disposed inside the package 31, and a filling material 32 which fills the inside of the package 31.

The package 31 has a disc-shaped substrate 311 and a cylindrical wall portion 312. The package 31 has an opening 313, and has a bottomed cylindrical shape having a space S3 formed in such a way that the substrate 311 and the wall portion 312 are joined to each other. The package 31 is installed in the accommodation space 4 so that the opening 313 faces the opening side of the accommodation space 4.

The substrate 311 has a wire and a terminal (not illustrated). The pressure sensor 30 is mounted on the substrate 311. The wall portion 312 has a large-diameter portion whose outer diameter and inner diameter are large, and a small-diameter portion whose outer diameter and inner diameter are smaller than those of the large-diameter portion.

The pressure sensor 30 detects pressure of the accommodation space 4, that is, pressure applied to the sensor unit 3, and outputs a signal corresponding to the detected pressure to a control unit (not illustrated). For example, the pressure sensor 30 is configured to include a small pressure sensor manufactured using a semiconductor manufacturing technique, such as a MEMS-type pressure sensor. More specifically, although not illustrated, for example, the pressure sensor 30 includes a diaphragm portion which is bent and deformed by receiving the pressure, and a deflection detection element, for example, such as a piezo-resistive element for detecting deflection of the diaphragm portion. As long as the pressure sensor 30 can detect the pressure, the pressure sensor 30 is not limited to the above-described configuration.

The filling material 32 is configured to contain a gel-like material, for example, such as silicone gel which is imcompressible and water-insoluble. The filling material 32 protects the pressure sensor 30, and propagates the pressure applied to the sensor unit 3 to the pressure sensor 30.

This sensor unit 3 is placed on the accommodation space 4 by a sealing member 40 such as an O-ring disposed so as to seal a portion between an inner wall surface of the recess configuring the accommodation space 4 and an outer peripheral surface of the small-diameter portion of the package 31.

Hitherto, a configuration of the wristwatch 1 has been described.

As described above, the wristwatch 1 serving as an example of the above-described pressure sensor-provided device according to the invention has the pressure sensor 30, the housing 2 that has the accommodation space 4 which accommodates the sensor unit 3 having the pressure sensor 30, the channel 61 (first channel) that has the opening 611 (first opening) disposed on the outer surface (outer peripheral surface) of the housing 2, and that connects the outside of the housing 2 and the accommodation space 4 to each other, and the channel 62 (second channel) that has the opening 621 (second opening) disposed on the outer surface (outer peripheral surface) of the housing 2, and that connects the outside of the housing 2 and the accommodation space 4 to each other. Then, the opening 611 and the opening 621 are disposed on the sides opposite to each other via the center O1 of the housing 2.

According to this wristwatch 1, for example, when wind blowing to the vicinity of the opening 611 increases pressure in the vicinity of the opening 611 and on the other hand, when pressure in the vicinity of the opening 621 becomes lower than the pressure in the vicinity of the opening 611, the wind can flow to the opening 621 after flowing through the channel 61 and the channel 62 from the opening 611. In this way, the wind entering the inside of the housing 2 can flow outward from the housing 2. Since air stagnation can be reduced, it is possible to restrain the pressure of the accommodation space 4 from varying due to a wind effect. Therefore, it is possible to reduce pressure variations caused by the wind effect. Therefore, according to the wristwatch 1, atmospheric pressure can be more accurately measured. Accordingly, a user can more accurately know an altitude.

Even in a case where wind blows to the vicinity of the opening 621, the wind can flow to the opening 611 after flowing through the channels 62 and the channels 61 from the opening 621. Accordingly, The same advantageous effect described above can be achieved.

Furthermore, the wristwatch 1 has the channel 63 (third channel) that has the opening 631 (third opening) disposed on the outer surface (outer peripheral surface) of the housing 2, and that connects the outside of the housing 2 and the accommodation space 4 to each other, and the channel 64 (fourth channel) that has the opening 641 (fourth opening) disposed on the outer surface (outer peripheral surface) of the housing 2, and that connects the outside of the housing 2 and the accommodation space 4 to each other. In this manner, the wind can flow between the opening 611 and the opening 621. In addition, the wind can flow between the opening 631 and the opening 641. For example, the wind entering from the opening 611 can flow to the openings 621, 631, and 641 through the channels 61, 62, 63, and 64. Therefore, even if the wind blows to the wristwatch 1, the wind entering the inside of the housing 2 from any one opening of the openings 611, 621, 631, and 641 can flow outward from the housing 2 through any other opening of the openings 611, 621, 631, and 641. Accordingly, compared to a configuration having two channels 61 and 62, it is possible to effectively reduce pressure variations caused by the wind effect.

In addition, according to the wristwatch 1, when four regions 20 are defined which are divided by the first plane A1 passing through the center O1 of the housing 2 and the second plane A2 passing through the center O1 of the housing 2 and intersecting the first plane A1, the openings 611, 621, 631, and 641 are respectively disposed inside different regions 20. In this manner, even if the wind blows to the wristwatch 1 in various directions, the wind entering the inside of the housing 2 from any one opening of the openings 611, 621, 631, and 641 can flow outward from the housing 2 through the opening different from the opening which the wind enters before. Therefore, regardless of a wind blowing direction, it is possible to effectively reduce pressure variations caused by the wind effect.

As described above, the channels 61, 62, 63, and 64 respectively have the same pressure loss with respect to the same fluid. In this manner, the accommodation space 4 can be a region which is particularly less likely to receive the wind effect. That is, it is possible to remove or reduce the influence of the pressure (dynamic pressure) generated by the blowing wind. Accordingly, it is possible to effectively reduce pressure variations caused by the wind effect.

According to the embodiment, as described above, each cross-sectional shape of the channels 61, 62, 63, and 64 is not limited to a square shape, and may be a rectangular shape in addition to the square shape, a polygonal shape in addition to the rectangular shape, or a circular shape. According to the embodiment, the channels 61, 62, 63, and 64 respectively have a constant width. However, the width may not be constant. The width may be discontinuous, or may be periodically changed. However, in order to effectively reduce the pressure variations caused by the wind effect, it is preferable that the channels 61, 62, 63, and 64 are respectively configured to have the same pressure loss in the same fluid.

As described above, the housing 2 has the symmetric shape via the first plane A1, and has the symmetric shape via the second plane A2. That is, as the symmetric plane, the housing 2 has the first plane A1 and the second plane A2, and is configured to have the symmetric shape. Then, as described above, the opening 611 and the opening 621 are respectively disposed at the position shifted from the first plane A1 and the second plane A2. In this manner, for example, even in a state where a user wears the wristwatch 1 on his or her arm, due to the wind effect wrapping around the outer periphery of the housing 2, differential pressure is likely to be generated between a location to which wind blows and a location opposite thereto. Therefore, it is possible to improve an operation effect of causing the wind to flow into the channel unit 6. It is possible to effectively reduce pressure variations caused by the wind effect.

According to the wristwatch 1, as described above, the accommodation space 4 is located below the connection portion 60. In this way, the accommodation space 4 is disposed at a position retracted downward from the channel unit 6 serving as a wind flowing route. In this manner, it is possible to further reduce pressure variations caused by the wind effect.

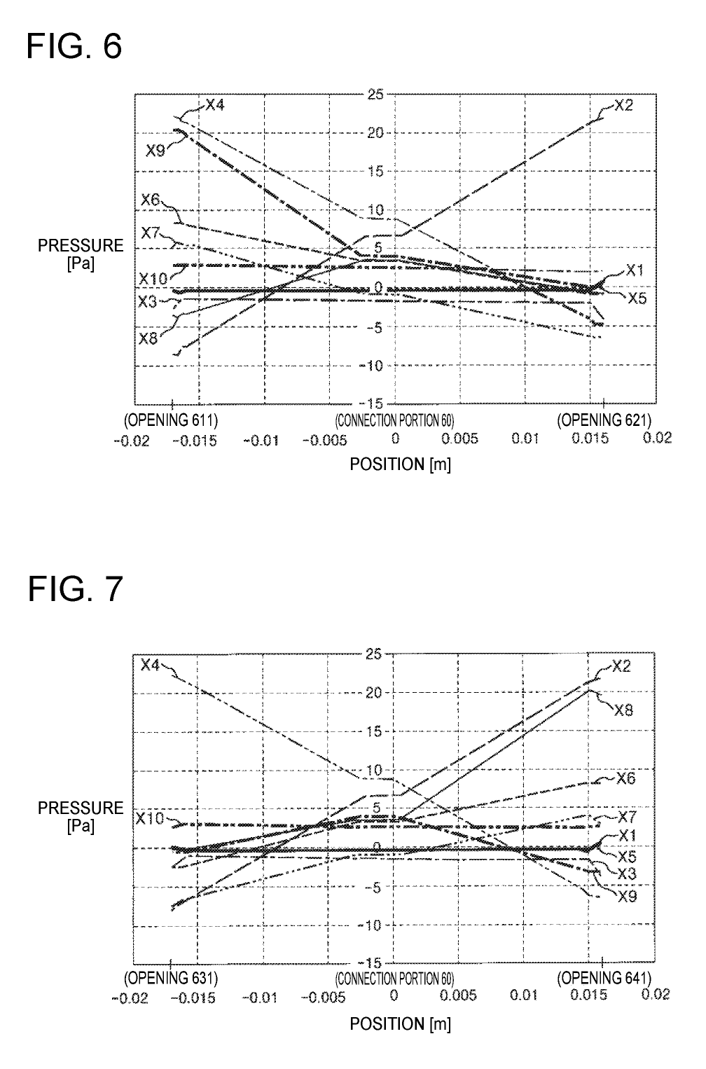

Hereinafter, an advantageous effect in which the wristwatch 1 can reduce the pressure variations caused by the wind effect regardless of a wind blowing direction will be described with reference to FIGS. 6 to 11.

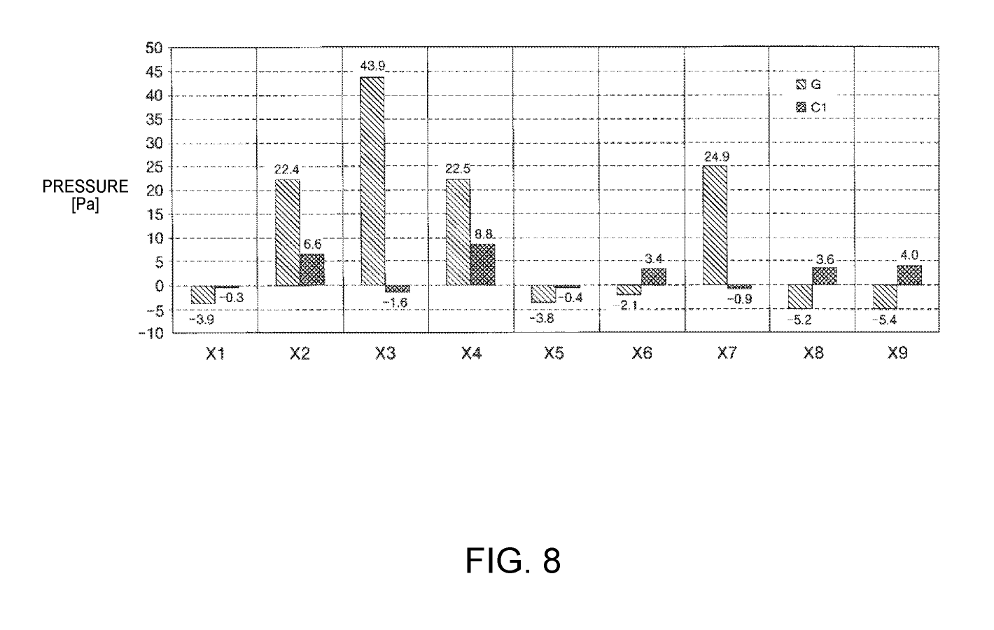

FIG. 6 is a view illustrating pressure distribution when the wristwatch illustrated in FIG. 1 receives wind. FIG. 7 is a view illustrating pressure distribution when the wristwatch illustrated in FIG. 1 receives wind. FIG. 8 is a view illustrating pressure in the cover member and the sensor unit, both of which belong to the wristwatch illustrated in FIG. 1. FIG. 9 is a schematic side view illustrating the wristwatch illustrated in FIG. 1. FIG. 10 is a schematic side view illustrating the wristwatch illustrated in FIG. 1. FIG. 11 is a schematic top view illustrating the wristwatch illustrated in FIG. 1.

First, with reference to FIGS. 6, 7, and 9 to 11, pressure distribution in the channel unit 6 when the wristwatch 1 receives wind will be described.

FIGS. 6 and 7 respectively illustrate the pressure distribution inside the wristwatch 1 when the wristwatch 1 receives the wind. FIG. 6 illustrates the pressure distribution in the channels 61 and 62. FIG. 7 illustrates the pressure distribution in the channels 63 and 64.

FIGS. 6 and 7 respectively illustrate pressure in a case where the wind blows at wind speed of 5 m/s, and illustrate pressure obtained by deducting pressure (static pressure) in a state where the wind does not blow from pressure (total pressure) in a case where the wind blows, that is, dynamic pressure.

A horizontal axis of a graph illustrated in FIG. 6 represents a position m from the opening 611 to the opening 621, 0 (zero) m represents the center of the connection portion 60, −(minus) side represents the channel 61, and +(plus) side represents the channel 62. On the other hand, a horizontal axis of a graph illustrated in FIG. 7 represents a position m from the opening 631 to the opening 641, 0 (zero) m represents the center of the connection portion 60, −(minus) side represents the channel 63, and +(plus) side represents the channel 64.

A line segment X1 illustrated in each of FIGS. 6 and 7 corresponds to an arrow x1 illustrated in FIG. 9, and indicates pressure when wind blows to the wristwatch 1 in a direction of the arrow x1. Similarly, a line segment X2 corresponds to an arrow x2 illustrated in FIG. 9, a line segment X3 corresponds to an arrow x3 illustrated in FIG. 9, a line segment X4 corresponds to an arrow x4 illustrated in FIG. 9, a line segment X5 corresponds to an arrow x5 illustrated in FIG. 9, a line segment X6 corresponds to an arrow x6 illustrated in FIG. 10, a line segment X7 corresponds to an arrow x7 illustrated in FIG. 10, a line segment X8 corresponds to an arrow x8 illustrated in FIG. 11, a line segment X9 corresponds to an arrow x9 illustrated in FIG. 11, and a line segment X10 corresponds to an arrow x10 illustrated in FIG. 9.

A graph illustrated in FIGS. 6 and 7 represents an investigation result obtained on the assumption of a state where the wristwatch 1 is attached to an arm H of a user by using a band B as illustrated in FIGS. 9 to 11.

As is visibly understood from line segments X1 to X10 illustrated in FIGS. 6 and 7, even if wind blows to the wristwatch 1 in any direction of the arrows x1 to x10 illustrated in FIG. 9, 10, or 11, in the connection portion 60, pressure 0 (zero) Pa or pressure close thereto, that is, static pressure or pressure close thereto is obtained. That is, it is understood that it is possible to remove or reduce the influence of dynamic pressure.

For example, if the wind blows toward the vicinity of the opening 611 as illustrated by the arrow x9 in FIG. 11, the pressure in the vicinity of the opening 611 increases as illustrated by the line segment X9 in FIGS. 6 and 7, and the pressure in the vicinity of the openings 621, 631, and 641 decreases. Since a differential pressure is generated in this way, the wind can flow from the opening 611 to the openings 621, 631, and 641. Then, pressure close to the static pressure is obtained in the connection portion 60.

For example, if the wind blows obliquely to a plate surface of the cover member 24 toward a location between the opening 621 and the opening 641 as illustrated by the arrow x2 in FIG. 9, the pressure in the vicinity of the opening 621 and the opening 641 increases as illustrated by the line segment X2 in FIGS. 6 and 7, and the pressure in the vicinity of the opening 611 and the opening 631 decreases. The pressure in the vicinity of the connection portion 60 becomes close to the static pressure.

For example, if the wind blows toward the cover member 24 from immediately above as illustrated by the arrow x3 in FIG. 9, a pressure difference is not generated among the openings 611, 621, 631, and 641 as illustrated by the line segment X3 in FIGS. 6 and 7. In the connection portion 60 and the channels 61, 62, 63, and 64, pressure close to the static pressure is obtained.

In this way, according to the wristwatch 1, it is understood that it is possible to obtain pressure close to the static pressure in the connection portion 60 even if the wind blows in any direction of the arrows x1 to x10.

Next, with reference to FIGS. 8 to 11, pressure in the cover member 24 and pressure in the sensor unit 3 when the wind blows to the wristwatch 1 will be described.

A bar graph G illustrated in FIG. 8 indicates pressure on a surface of the cover member 24, and a bar graph C1 indicates pressure on a surface of the filling material 32 of the sensor unit 3. Similarly to the above-described configuration, FIG. 8 also illustrates the dynamic pressure when the wind blows at the wind speed of 5 m/s. Similarly to the above-described configuration, the line segments X1 to X9 illustrated in FIG. 8 also respectively correspond to the arrows x1 to x9 illustrated in FIGS. 9 to 11.

It is understood that pressure in the sensor unit 3 can be pressure close to the static pressure as illustrated in FIG. 8 even if the wind blows to the wristwatch 1 in any direction of the arrows x1 to x9 illustrated in FIG. 9, 10, or 11. That is, it is understood that it is possible to remove or reduce the influence of the dynamic pressure.

In particular, even if the pressure in the cover member 24 increases due to the wind blowing from above the cover member 24 as illustrated by the arrows x2, x3, x4, and x7, the dynamic pressure inside the housing 2 is reduced. For this reason, according to the wristwatch 1, it is understood that it is possible to reduce pressure variations caused by the wind effect.

Hitherto, the wristwatch 1 serving as an example of the pressure sensor-provided device according to the invention has been described. As described above, according to the embodiment, as an example of the pressure sensor-provided device according to the invention, the wristwatch 1 has been described which has the display unit 10 disposed in the housing 2 so as to display time information. The wristwatch 1 is used by being worn on a user's arm, and is likely to receive the wind effect by the user's arm being shaken. Therefore, the pressure sensor-provided device according to the invention is effectively used as the wristwatch 1 which is particularly likely to receive the wind effect, since pressure can be more accurately measured.

### Second Embodiment

Next, a second embodiment according to the invention will be described.

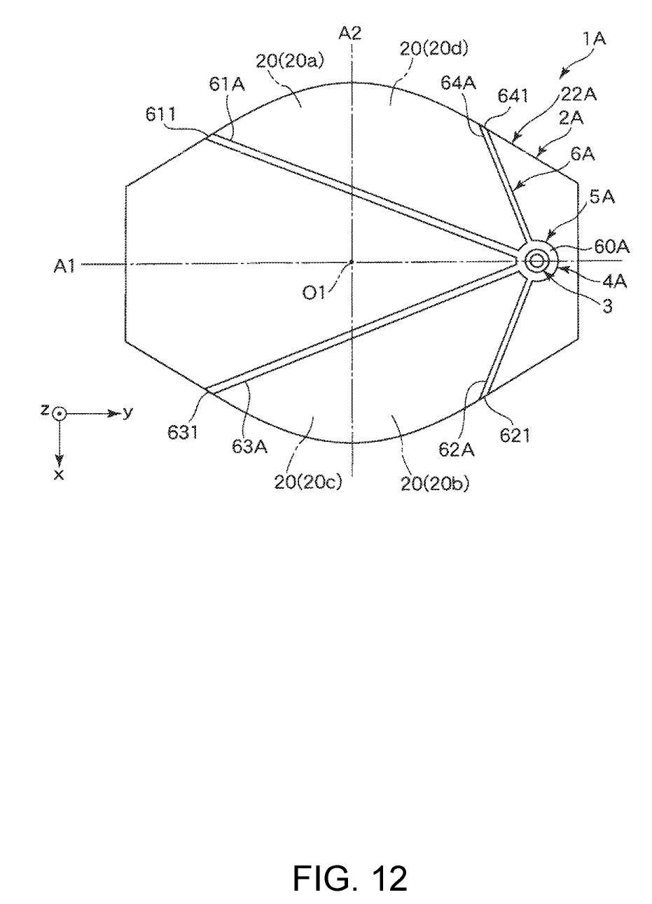

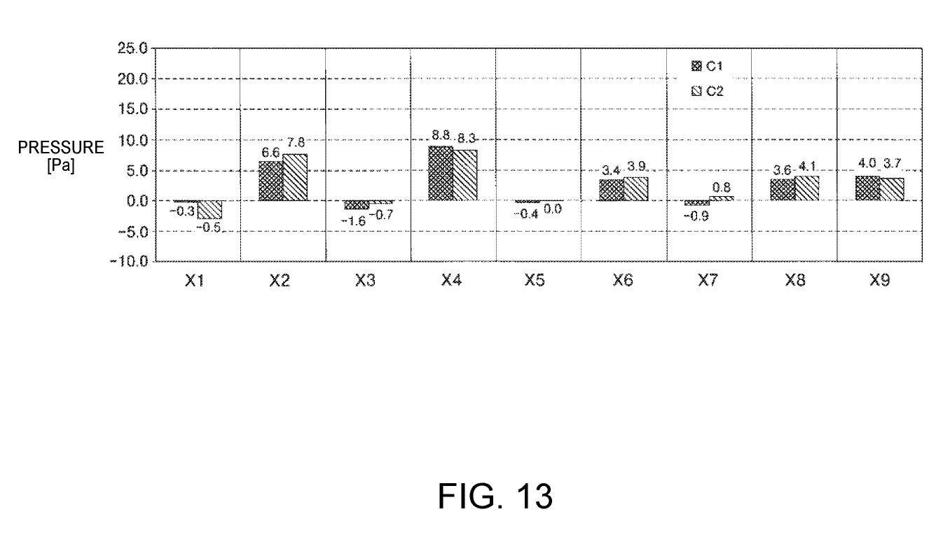

FIG. 12 is a schematic plan view of a wristwatch serving as an example of the pressure sensor-provided device according to the second embodiment of the invention. FIG. 13 is a view illustrating pressure in a sensor unit when the wristwatch illustrated in FIG. 12 receives wind.

The wristwatch serving as an example of the pressure sensor-provided device according to the embodiment is the same as that according to the above-described first embodiment, except for a different configuration of an internal space.

In the following description, with regard to the second embodiment, points different from those in the above-described embodiment will be mainly described. Description of the same points will be omitted. In FIGS. 12 and 13, the same reference numerals will be respectively given to configurations which are the same as those in the above-described embodiment.

An internal space 5A formed in a rear cover 22A of a housing 2A belonging to a wristwatch 1A illustrated in FIG. 12 has a channel unit 6A and an accommodation space 4A. The accommodation space 4A is disposed on an edge portion side of the rear cover 22A in a plan view.

### Channel Unit 6A

The channel unit 6A has a channel 61A (first channel), a channel 62A (second channel), a channel 63A (third channel), a channel 64A (fourth channel), and a connection portion 60A. The connection portion 60A is disposed on an edge portion side of the rear cover 22A in a plan view. According to the embodiment, as illustrated, the connection portion 60A is disposed on the +y-axis side from the center O1.

The length of the channel 61A is longer than the length of the channel 62A. The length of the channel 63A is longer than the length of the channel 64A. The length of the channel 61A and the length of the channel 63A are the same as each other. The length of the channel 62A and the length of the channel 64A are the same as each other.

The width of the channel 61A is wider than the width of the channel 62A. The width of the channel 63A is wider than the width of the channel 64A. The width of the channel 61A and the width of the channel 63A are the same as each other. The width of the channel 62A and the width of the channel 64A are the same as each other. The equivalent diameter within (inside) each tube of the channels 61A, 62A, 63A, and 64A satisfies a relationship which is the same as a relationship of each width of the channels 61A, 62A, 63A, and 64A.

In this way, according to the embodiment, each length of the channels 61A and 63A is longer than each length of the channels 62A and 64A. Each width of the channels 61A and 63A is wider than each width of the channels 62A and 64A. In this way, each width and each length of the channels 61A, 62A, 63A, and 64A are adjusted. In this manner, the respective pressure losses of the channels 61A, 62A, 63A, and 64A can be equalized, and the connection portion 60A can be disposed on the edge portion side of the rear cover 22A. Accordingly, similarly to the first embodiment, the accommodation space 4A communicating with the connection portion 60A can be a region which is particularly less likely to receive the wind effect.

### Accommodation Space 4A

The accommodation space 4A is located below (rear side) the connection portion 60A. As described above, the accommodation space 4A is disposed on the edge portion side of the rear cover 22A in a plan view. According to the embodiment, as illustrated, the accommodation space 4A is disposed on the +y-axis side from the center O1. In this way, the accommodation space 4A is disposed at a position shifted from the center O1 of the housing 2A. Accordingly, it is possible to avoid an arrangement of various components from being limited by the accommodation space 4A. Therefore, the various components can be more freely arranged.

According to the wristwatch 1A having this configuration, as illustrated in FIG. 13, similarly to the first embodiment, it is also possible to reduce pressure variations caused by the wind effect, regardless of a wind blowing direction.

A bar graph C1 illustrated in FIG. 13 indicates pressure in the sensor unit 3 of the wristwatch 1 according to the first embodiment, and a bar graph C2 indicates pressure in the sensor unit 3 of the wristwatch 1A according to the present embodiment.

Even if the wind blows to the wristwatch 1A in any direction of the arrows x1 to x9 illustrated in FIG. 9, 10, or 11, pressure in the sensor unit 3 can be pressure close to the static pressure as illustrated in FIG. 13. According to the wristwatch 1A in the embodiment, it is also understood that the sensor unit 3 has pressure substantially the same as that in the wristwatch 1 according to the first embodiment. Therefore, according to the wristwatch 1A, similarly to the first embodiment, it is understood that it is possible to reduce pressure variations caused by the wind effect.

### Third Embodiment

Next, a third embodiment according to the invention will be described.

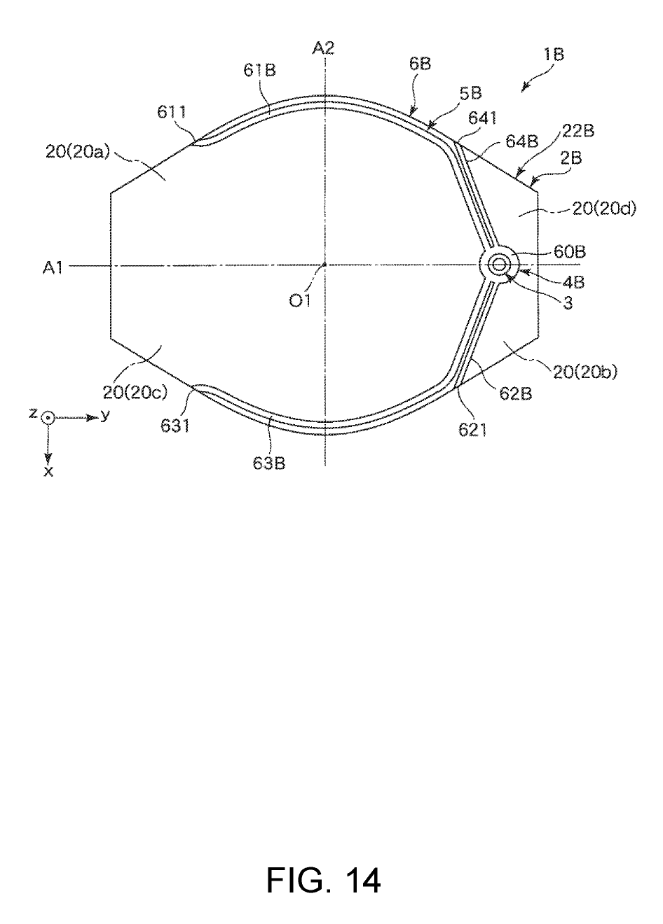

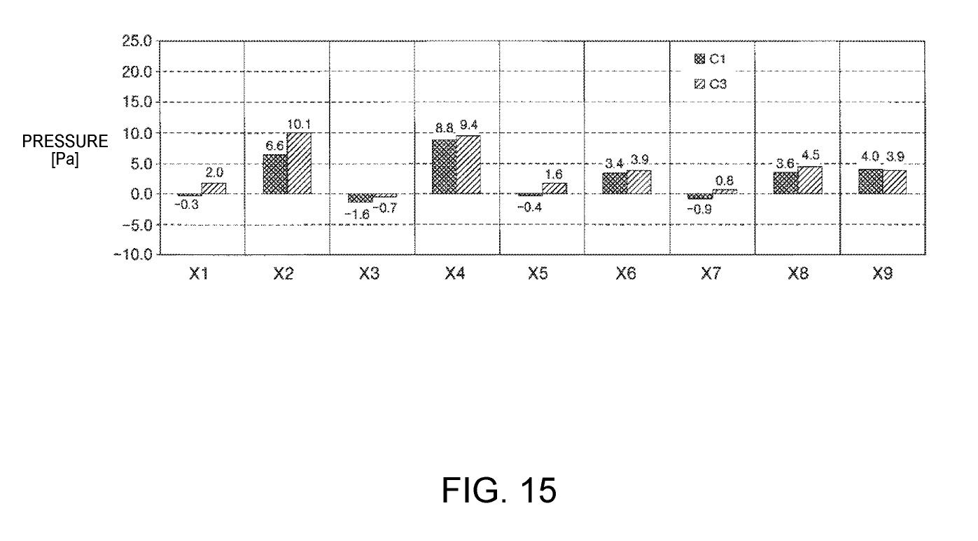

FIG. 14 is a schematic plan view of a wristwatch serving as an example of a pressure sensor-provided device according to the third embodiment of the invention. FIG. 15 is a view illustrating pressure in a sensor unit when the wristwatch illustrated in FIG. 14 receives wind.

The wristwatch serving as an example of the pressure sensor-provided device according to the embodiment is the same as that according to the above-described second embodiment, except for a different configuration of a channel unit.

In the following description, with regard to the third embodiment, points different from those in the above-described embodiment will be mainly described. Description of the same points will be omitted. In FIGS. 14 and 15, the same reference numerals will be respectively given to configurations which are the same as those in the above-described embodiment.

An internal space 5B formed in a rear cover 22B of a housing 2B belonging to a wristwatch 1B illustrated in FIG. 14 has a channel unit 6B and an accommodation space 4B. The channel unit 6B is disposed on an edge portion side of the rear cover 22B.

### Channel Unit 6B

The channel unit 6B has a channel 61B (first channel), a channel 62B (second channel), a channel 63B (third channel), a channel 64B (fourth channel), and a connection portion 60B.

The channels 61B and 63B belonging to the channel unit 6B respectively have a curve shape in a plan view, and are formed along an outer periphery of the rear cover 22B.

Similarly to the second embodiment, each length of the channels 61B and 63B is longer than each length of the channels 62B and 64B. Each width of the channels 61B and 63B is wider than each width of the channels 62B and 64B. In this way, each width and each length of the channels 61B, 62B, 63B, and 64B are adjusted. In this manner, the respective pressure losses in the same fluid of the respective channels 61B, 62B, 63B, and 64B can be equalized. The channels 61B, 62B, 63B, 64B, and the connection portion 60B can be disposed on the edge portion side of the rear cover 22B. Accordingly, the accommodation space 4B communicating with the connection portion 60B can be a region which is particularly less likely to receive the wind effect. Various components can be more freely arranged.

In particular, as described above, the channels 61B and 63B respectively have a portion extending along the outer periphery of the rear cover 22B, that is, a portion extending along the outer surface (outer peripheral surface) of the housing 2B. Therefore, it is possible to further improve a free arrangement of components. For example, the various components can be arranged in the vicinity of the center O1 of the housing 2B.

The embodiment adopts a configuration in which the channels 61B and 63B have the portion extending along the outer peripheral surface of the housing 2B. However, the embodiment may adopt a configuration in which the channels 62B and 64B also have the portion extending along the outer peripheral surface of the housing 2B.

According to the wristwatch 1B having this configuration, as illustrated in FIG. 15, similarly to the first embodiment, it is also possible to reduce pressure variations caused by the wind effect, regardless of a wind blowing direction.

The bar graph C1 illustrated in FIG. 15 indicates pressure in the sensor unit 3 of the wristwatch 1 according to the first embodiment, and a bar graph C3 indicates pressure in the sensor unit 3 of the wristwatch 1B according to the present embodiment.

Even if the wind blows to the wristwatch 1B in any direction of the arrows x1 to x9 illustrated in FIG. 9, 10, or 11, pressure in the sensor unit 3 can be pressure close to the static pressure as illustrated in FIG. 15. According to the wristwatch 1B in the embodiment, it is also understood that the sensor unit 3 has pressure substantially the same as that in the wristwatch 1 according to the first embodiment. Therefore, according to the wristwatch 1B, similarly to the first embodiment, it is understood that it is possible to reduce pressure variations caused by the wind effect.

### Fourth Embodiment

Next, a fourth embodiment according to the invention will be described.

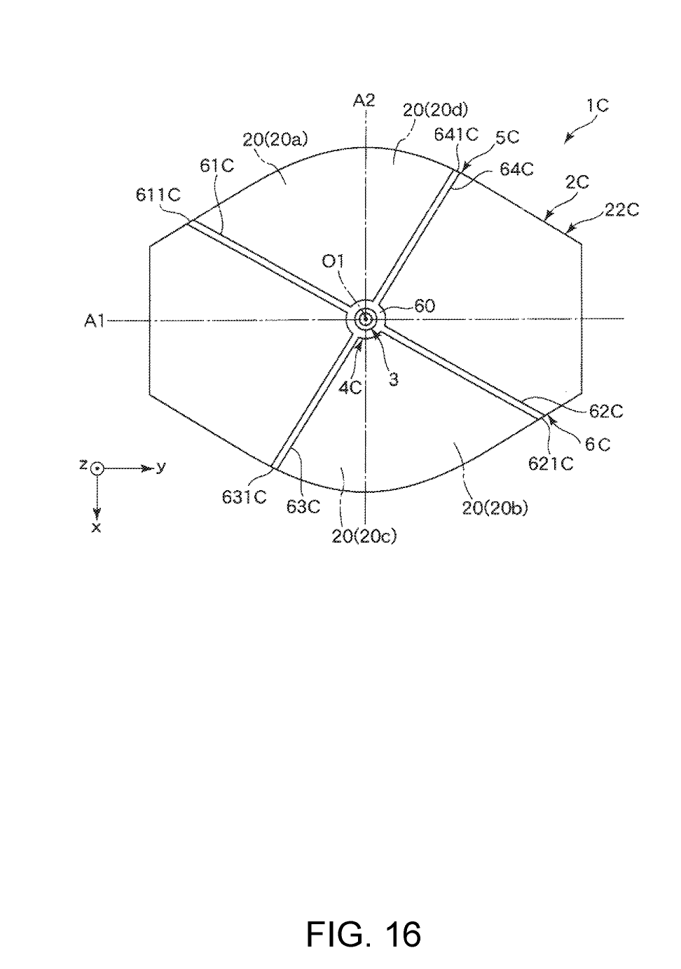

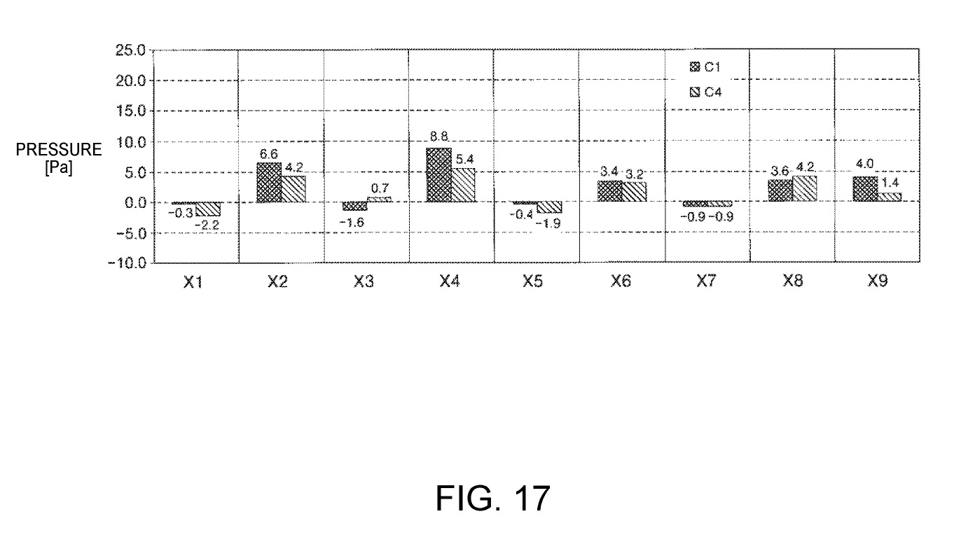

FIG. 16 is a schematic plan view of a wristwatch serving as an example of a pressure sensor-provided device according to the fourth embodiment of the invention. FIG. 17 is a view illustrating pressure in a sensor unit when the wristwatch illustrated in FIG. 16 receives wind.

The wristwatch serving as an example of the pressure sensor-provided device according to the embodiment is the same as that according to the above-described first embodiment, except for a different configuration of a channel unit.

In the following description, with regard to the fourth embodiment, points different from those in the above-described embodiment will be mainly described. Description of the same points will be omitted. In FIGS. 16 and 17, the same reference numerals will be respectively given to configurations which are the same as those in the above-described embodiment.

An internal space 5C formed in a rear cover 22C of a housing 2C belonging to a wristwatch 1C illustrated in FIG. 16 has a channel unit 6C and an accommodation space 4C. Each position of the channels 61C, 62C, 63C, and 64C belonging to the channel unit 6C is different from that of the channels 61, 62, 63, and 64 in the first embodiment.

### Channel Unit 6C

The channel unit 6C has a channel 61C (first channel) having an opening 611C (first opening), a channel 62C (second channel) having an opening 621C (second opening), a channel 63C (third channel) having an opening 631C (third opening), a channel 64C (fourth channel) having an opening 641C (fourth opening), and the connection portion 60.

According to the embodiment, the channels 61C, 62C, 63C, and 64C are respectively disposed at positions rotated counterclockwise in FIG. 16 by approximately 30° around a line segment parallel to the z-axis direction, as the central axis, which passes through the center O1 from the corresponding channels 61, 62, 63, and 64 in the first embodiment in a plan view. Similarly, the opening 611C, 621C, 631C, and 641C are also respectively disposed at positions rotated counterclockwise in FIG. 16 by approximately 30° around a line segment parallel to the z-axis direction, as the central axis, which passes through the center O1 from the corresponding openings 611, 621, 631, and 641 in the first embodiment in a plan view.

According to the embodiment, each width and each length of the channels 61C, 62C, 63C, and 64C are also adjusted, thereby equalizing the respective pressure losses in the same fluid of the respective channels 61C, 62C, 63C, and 64C.

The channel unit 6C having this configuration has an asymmetric shape via the first plane A1 which is a symmetric plane, and has an asymmetric shape via the second plane A2 which is a symmetric plane. In this manner, it is possible to further reduce pressure variations caused by the wind effect, regardless of a wind blowing direction.

According to the wristwatch 1C having this configuration, as illustrated in FIG. 17, similarly to the first embodiment, it is also possible to reduce pressure variations caused by the wind effect, regardless of a wind blowing direction.

The bar graph C1 illustrated in FIG. 17 indicates pressure in the sensor unit 3 of the wristwatch 1 according to the first embodiment, and a bar graph C4 indicates pressure in the sensor unit 3 of the wristwatch 1C according to the present embodiment.

Even if the wind blows to the wristwatch 1C in any direction of the arrows x1 to x9 illustrated in FIG. 9, 10, or 11, pressure in the sensor unit 3 can be pressure close to the static pressure as illustrated in FIG. 17. According to the wristwatch 1C in the embodiment, it is also understood that the sensor unit 3 has pressure substantially the same as that in the wristwatch 1 according to the first embodiment. In particular, the wristwatch 1 according to the first embodiment is likely to receive the wind effect of the wind blowing in the directions of the arrows x2 and x4. However, according to the wristwatch 1C in the embodiment, it is possible to reduce pressure variations caused by the wind effect of the wind blowing in these directions.

### Fifth Embodiment

Next, a fifth embodiment according to the invention will be described.

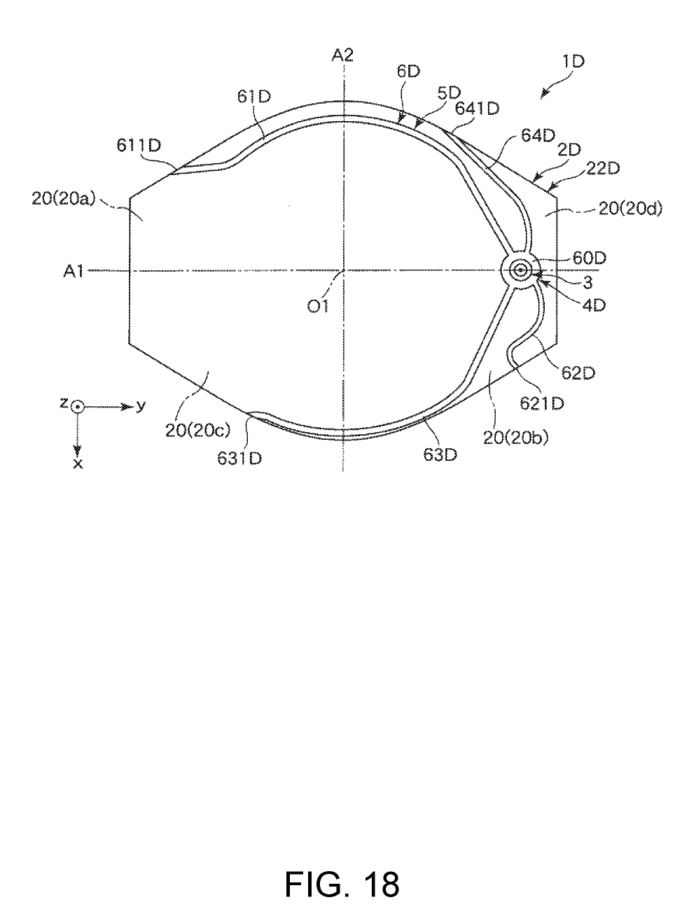

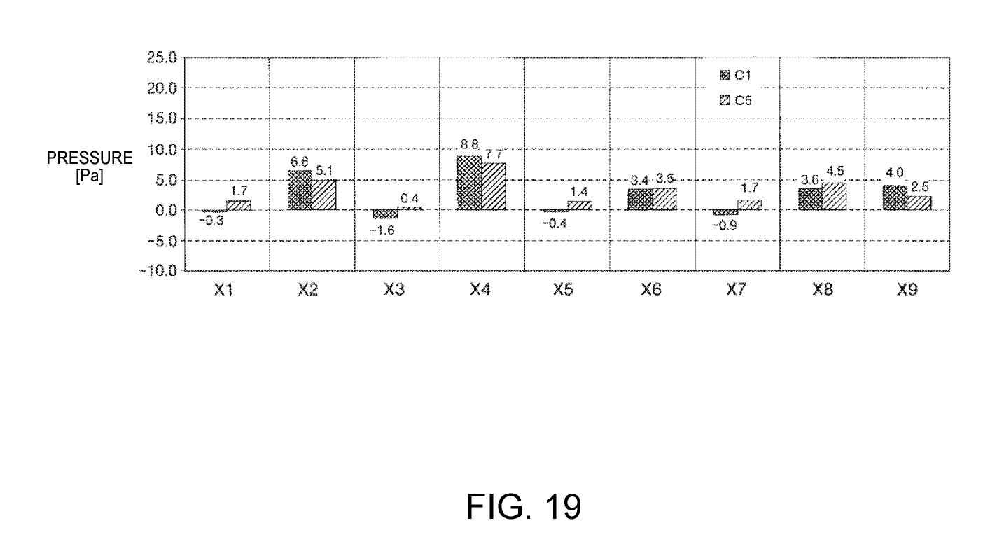

FIG. 18 is a schematic plan view of a wristwatch serving as an example of a pressure sensor-provided device according to the fifth embodiment of the invention. FIG. 19 is a view illustrating pressure in a sensor unit when the wristwatch illustrated in FIG. 18 receives wind.

The wristwatch serving as an example of the pressure sensor-provided device according to the embodiment is the same as that according to the above-described fourth embodiment, except for a different configuration of an internal space.

In the following description, with regard to the fifth embodiment, points different from those in the above-described embodiment will be mainly described. Description of the same points will be omitted. In FIGS. 18 and 19, the same reference numerals will be respectively given to configurations which are the same as those in the above-described embodiment.

An internal space 5D formed in a rear cover 22D of a housing 2D belonging to a wristwatch 1D illustrated in FIG. 18 has a channel unit 6D and an accommodation space 4D. The channel unit 6D is disposed on an edge portion side of the rear cover 22D.

### Channel Unit 6D

The channel unit 6D has a channel 61D (first channel) having an opening 611D (first opening), a channel 62D (second channel) having an opening 621D (second opening), a channel 63D (third channel) having an opening 631D (third opening), a channel 64D (fourth channel) having an opening 641D (fourth opening), and a connection portion 60D.

The channels 61D, 62D, 63D, and 64D belonging to the channel unit 6D respectively have a curve shape in a plan view. The channels 61D and 63D are formed along an outer periphery of the rear cover 22D.

The connection portion 60D is disposed on an edge portion side of the rear cover 22D. According to the embodiment, as illustrated, the connection portion 60D is disposed on the +y-axis side from the center O1.

According to the embodiment, similarly to the fourth embodiment, the opening 611D, 621D, 631D, and 641D are also respectively disposed at positions rotated counterclockwise in FIG. 18 by approximately 30° around a line segment parallel to the z-axis direction, as the central axis, which passes through the center O1 from the corresponding openings 611, 621, 631, and 641 in the first embodiment in a plan view. According to the embodiment, each width and each length of the channels 61D, 62D, 63D, and 64D are also adjusted, thereby equalizing the respective pressure losses in the same fluid of the respective channels 61D, 62D, 63D, and 64D. Then, the channel unit 6D has an asymmetric shape via the first plane A1 which is a symmetric plane, and has an asymmetric shape via the second plane A2 which is a symmetric plane. In this manner, it is possible to further reduce pressure variations caused by the wind effect, regardless of a wind blowing direction.

### Accommodation Space 4D

The accommodation space 4D is located on the end portion side of the rear cover 22D in a plan view. According to the embodiment, as illustrated, the accommodation space 4D is disposed on the +y-axis side from the center O1.

As described above, the channels 61D, 62D, 63D, 64D, the connection portion 60D, and the accommodation space 4D are disposed on the edge portion side of the rear cover 22D. Accordingly, it is possible to improve a free arrangement of various components. For example, the various components can be arranged in the vicinity of the center O1 of the housing 2D.

According to the wristwatch 1D having this configuration, as illustrated in FIG. 19, similarly to the first embodiment, it is also possible to reduce pressure variations caused by the wind effect, regardless of a wind blowing direction.

The bar graph C1 illustrated in FIG. 19 indicates pressure in the sensor unit 3 of the wristwatch 1 according to the first embodiment, and a bar graph C5 indicates pressure in the sensor unit 3 of the wristwatch 1D according to the present embodiment.

Even if the wind blows to the wristwatch 1D in any direction of the arrows x1 to x9 illustrated in FIG. 9, 10, or 11, pressure in the sensor unit 3 can be pressure close to the static pressure as illustrated in FIG. 19. According to the wristwatch 1D in the embodiment, it is also understood that the sensor unit 3 has pressure substantially the same as that in the wristwatch 1 according to the first embodiment. In particular, the wristwatch 1 according to the first embodiment is likely to receive the wind effect of the wind blowing in the directions of the arrows x2 and x4. However, according to the wristwatch 1D in the embodiment, it is possible to reduce pressure variations caused by the wind effect of the wind blowing in these directions.

Hitherto, the pressure sensor-provided device according to the invention has been described with reference to the illustrated embodiments. The invention is not limited thereto, and a configuration of each unit can be substituted with any desired configuration having the same function. Alternatively, any desired configuration may be added thereto. In the invention, any two or more desired configurations in the above-described respective embodiments may be combined with each other.

In the above-described embodiments, the wristwatch serving as the pressure sensor-provided device according to the invention has been described as an example. However, the pressure sensor-provided device according to the invention is not limited to the wristwatch. For example, the pressure sensor-provided device according to the invention may be a pressure gauge which can obtain only pressure without including the display unit for displaying time information. The pressure sensor-provided device according to the invention may be a water depth gauge in which a fluid entering the channel unit is a liquid, for example, such as water, and which can obtain a water depth, based on pressure of the liquid. For example, the pressure sensor-provided device according to the invention can be applied to a smartphone, a tablet terminal, a personal computer, a wearable terminal such as a head mounted display (HMD), a video camera, a car navigation device, an electronic game device, a robot such as industrial robot, an unmanned aircraft such as a drone, or mobile equipment such as a vehicle and an airplane.

In the above-described embodiments, the accommodation space and the channel unit are disposed in the rear cover of the housing. However, these may be disposed at any location. For example, these may be disposed in a member (not illustrated) disposed in the body or inside the housing.

In the above-described embodiments, the channel unit is disposed along the plate surface of the rear cover, that is, along the direction orthogonal to the thickness direction of the housing. However, the channel unit may not be disposed along the direction orthogonal to the thickness direction of the housing. For example, depending on a configuration of the housing, the first opening may be disposed on the outer peripheral surface of the rear cover. The second opening may be disposed on the outer peripheral surface of the body. The first channel, the connection portion, and the second channel may be disposed in a member (not illustrated) disposed on a line segment which connects the first opening and the second opening to each other.

In the above-described embodiments, the channel unit has the four channels. However, without being limited thereto, the number may be three, five, or more.

The entire disclosure of Japanese Patent Application No. 2016-056601, filed Mar. 22, 2016 is expressly incorporated by reference herein.

What is claimed is:

1. A pressure sensor-provided device comprising:
a pressure sensor;
a housing that has an accommodation space which accommodates the pressure sensor;
a first channel that has a first opening disposed on an outer surface of the housing, and that connects an outside of the housing and the accommodation space to each other; and
a second channel that has a second opening disposed on the outer surface of the housing, and that connects the outside of the housing and the accommodation space to each other,
wherein the first opening and the second opening are respectively disposed on sides opposite to each other via a center of the housing.

2. The pressure sensor-provided device according to claim 1,
wherein pressure loss of a fluid in the first channel is equal to pressure loss of the fluid in the second channel.

3. The pressure sensor-provided device according to claim 1,
wherein the accommodation space is disposed at a position shifted from the center of the housing.

4. The pressure sensor-provided device according to claim 1,
wherein at least one of the first channel and the second channel has a portion extending along the outer surface of the housing.

5. The pressure sensor-provided device according to claim 1,
wherein a length of the first channel is longer than a length of the second channel, and
wherein a width of the first channel is wider than a width of the second channel.

6. The pressure sensor-provided device according to claim 1,
wherein the housing has a symmetric plane, and is configured to have a symmetric shape, and
wherein the first opening and the second opening are respectively disposed at positions shifted from the symmetric plane.

7. The pressure sensor-provided device according to claim 1, further comprising:
a third channel that has a third opening disposed on the outer surface of the housing, and that connects the outside of the housing and the accommodation space to each other; and
a fourth channel that has a fourth opening disposed on the outer surface of the housing, and that connects the outside of the housing and the accommodation space to each other.

8. The pressure sensor-provided device according to claim 7,
wherein when four regions are defined which are divided by a first plane passing through the center of the housing and a second plane passing through the center of the housing and intersecting the first plane, the first opening, the second opening, the third opening and the fourth opening are respectively disposed inside the different regions.

9. The pressure sensor-provided device according to claim 1, further comprising:
a display unit that is disposed in the housing, and that displays time information.
